(19) United States
(12) Patent Application Publication
(10) Pub. No.: US 2006/0177664 A1
(43) Pub. Date: Aug. 10, 2006

(54) Glass member

(76) Inventors: Takashi Naitou, Mito (JP); Motoyuki Miyata, Hitachinaka (JP); Hiroyuki Akata, Hitachi (JP); Yuichi Sawai, Hitachi (JP); Osamu Shiono, Hitachi (JP); Tatsumi Hirano, Hitachinaka (JP); Hiroki Yamamoto, Hitachi (JP); Hideto Momose, Hitachiota (JP); Takao Miwa, Hitachinaka (JP); Yuzo Kozono, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/224,096

(22) Filed: Sep. 13, 2005

(30) Foreign Application Priority Data
Sep. 17, 2004 (JP) 2004-272244

(51) Int. Cl. B32B 17/00; B32B 17/06

(52) U.S. Cl. 428/410; 428/426

(57) ABSTRACT

The present invention is envisioned to provide a high-strength glass which is applicable to the objective of size and weight reduction. At a surface portion of the glass containing a rare earth element, a heterogeneous phase containing at least said rare earth element is formed.

### FIELD OF THE INVENTION

The present invention relates to a high-strength glass member which is drastically improved in shatter resistance and finds useful application to various kinds of structural members, glass products and other products utilizing glass which are required to maintain shatter resistance even if reduced in size and weight.

### BACKGROUND OF THE INVENTION

Glass is utilized for a very wide variety of articles ranging from tableware, window glass and its sort which are found close to us, to electronic devices such as displays and storages and transportation means such as various kinds of vehicles and aircraft. It has been the general concept that glass is fragile and easily broken, and realization of unbreakable glass has been but a fantasy. As means for strengthening glass, there have been known several methods such as chemical strengthening, air blast cooling and crystallization. Nevertheless, even with the glass which has had such strengthening treatments, or so-called strengthened glass, the improvement of strength is limited to approximately double to thrice the strength of the non-treated glass (ordinary glass). In this field of industry, development of high-strength glass having four or more times higher strength than ordinary glass is being pushed ahead for application to flat panel displays (FPD).

It is considered that shatter (break) of glass occurs as the innumerable microcracks existing in the glass surface are forced to grow up to the greater cracks when a bending stress is exerted thereto. It is impossible to eliminate such microcracks from the glass surface. Therefore, it has been tried to obtain so-called strengthened glass by subjecting ordinary glass to the various strengthening treatments such as mentioned above.

As an example of glass strengthening treatments, Patent Document 1 discloses a chemical strengthening treatment in which a rare earth oxide (such as La₂O₃, Y₂O₃ or CeO₂) is incorporated in ordinary glass in an amount of 1% by weight or less. Also, Patent Document 2 discloses a method in which ultra-shortwave laser is applied to ordinary glass to form a heterogeneous phase in the surface portion of this glass to thereby inhibit growth of the cracks.

Air blast cooling is a treatment in which cold air is blown against the heated glass surface to form a compression strengthened layer on this glass surface to thereby prevent formation of cracks. This treatment is principally targeted at the large-sized plate glass, 4 mm or greater in thickness, which is mostly used for vehicles or building materials. The crystallization method features forming the crystal grains with a size of 100 nm or greater in the inside of amorphous glass to suppress the growth of the microcracks to the larger cracks in the glass surface by the presence of the crystal grains, thereby to strengthen the whole body of glass.

Patent Document 1: JP-A-2001-302278

Patent Document 2: JP-A-2003-286048

### BRIEF SUMMARY OF THE INVENTION

In the chemical strengthening method which is a conventional concept of means for strengthening glass, the glass surface is subjected to alkali ion exchange in a heated and melted nitrate for replacing Li ions in the surface portion of ordinary glass with Na ions, and the Na ions in the surface portion of ordinary glass with K ions, to form a compression strengthened layer on the glass surface. “Unbreakable glass” is required to have strength which is about 10 times that of ordinary glass as a result of the strengthening treatments. The strength enhancing effect by the conventional chemical treatments, however, is limited to about double or thrice higher strength than ordinary glass and far from being capable of providing “unbreakable glass”. Further, such strengthened glass involves the problem of low heat resistance (drop of strength on heating). Also, strength of the “strengthened glass” obtained by the conventional crystallization treatment is only about double that of ordinary glass, and such “strengthened glass” is low in transparency. As viewed above, it has been hardly possible to realize unbreakable glass with the prior art technology.

An object of the present invention is to provide a high-strength glass which is applicable to the scheme for size and weight reduction. The high-strength glass according to the present invention is capable of realizing enhancement of strength by about 6 to 10 times over the ordinary glass and finds its useful application to a wide variety of articles such as mentioned above including substrates for FPD, various kinds of glass-utilizing products, building materials, etc.

In order to attain the above object, the present invention features forming, at a surface portion of a glass member containing at least a rare earth element, a strengthened layer comprising a layer of a heterogeneous phase containing at least the said rare earth element. The “surface portion” of glass referred to in this invention signifies the portion of the glass in the very shallow region from the outermost surface of the glass, which will be further explained in the section of Examples.

The said rare earth element is at least one element selected from the group consisting of Pr, Nd, Sm, Eu, Gd, Tb, Dy, Ho, Er, Tm, Yb and Lu, preferably from the group consisting of Eu, Gd, Dy, Tm, Yb and Lu, more preferably it is Gd.

In the present invention, said heterogeneous phase is formed by irradiation with ultra-short pulse laser so that it will exist in the region within the depth of 300 μm from the outermost surface on one side, preferably on both sides, of said glass.

In the present invention, a rare earth element is contained in the glass in an amount of 1 to 10% by weight, preferably 2 to 7% by weight, calculated as an oxide thereof Ln₂O₃ (Ln: rare earth element).

In the present invention, a high-density heterogeneous phase containing a rare earth element is formed at the surface portion of the glass by applying ultra-short pulse laser, for example femtosecond laser, to the surface portion of the glass containing a rare earth element. This high-density heterogeneous phase containing a rare earth element functions to check growth of the microcracks to the larger cracks when a bending stress is exerted to the glass. Since formation of this heterogeneous phase does not depend on alkali ion exchange in the surface portion of the glass such as practiced in the chemical strengthening treatment, there is no need of incorporating an alkali in the glass to be strengthened.

In the portion irradiated with femtosecond laser, the particles containing a rare earth element are caused to separate out in the surface portion of the glass to form a high-density heterogeneous phase, which strengthens the glass surface and inhibits the microcracks from growing up to the larger cracks. By containing a rare earth element in the glass, it becomes possible to form a high-density and high-crystallinity heterogeneous phase.

As the rare earth element, Pr, Nd, Sm, Eu, Gd, Tb, Dy, Ho, Er, Tm, Yb or Lu, preferably Eu, Gd, Dy, Tm, Yb or Lu, more preferably Gd is used. The glass containing Eu, Gd, Dy, Tm, Yb or Lu has high light transmittance in the visible light region. Particularly, when Gd is contained, it is possible to satisfy, at remarkably high levels, both requirements for enhancement of strength and good light transmittance in the visible light region.

In the present invention, ultra-short pulse laser is applied to a prescribed depth of the surface portion of the glass to form a heterogeneous phase. Since irradiation with ultra-short pulse laser such as femtosecond laser gives no thermal influence to the glass, such as often observed in ordinary laser irradiation, there is no fear that a strain be built up in the glass after laser irradiation.

A high glass strengthening effect can be obtained by forming a heterogeneous phase in the glass region which is within 300 μm in depth from the outermost surface of the glass. This is because at a depth exceeding 300 μm, the effect of inhibiting growth of the already existing microcracks in the glass surface to the larger cracks is lessened, and there rather is produced a tendency to lower strength of the glass. Even higher strengthening can be realized by forming the heterogeneous phase on both sides of the glass.

When the content of Ln₂O₃ is less than 1% by weight, its strength enhancing effect is small. When its content exceeds 10% by weight, the treated glass tends to devitrify (crystallize). In view of this, the preferred range of content of Ln₂O₃ is 2 to 7% by weight.

The scope of use of the present invention is not limited to the structural components of the display devices and the glass structural members of electronic devices such as substrates of magnetic discs; the invention can be also applied widely to the other objectives such as structural materials and window glass (including 2-layer glass and laminated glass) of buildings, substrates for solar batteries, structural members and window glass of vehicles, aircraft, spacecraft, etc., for which high strength and reduction of size and weight are essential requirements.

Other objects, features and advantages of the invention will become apparent from the following description of the embodiments of the invention taken in conjunction with the accompanying drawings.

### BRIEF DESCRIPTION OF THE DRAWINGS

FIG. 1 is drawings illustrating comparatively the means for the glass strengthening treatment according to the present invention and the conventional means.

FIG. 2 is a diagrammatic illustration of the glass strengthening mechanism according to the present invention.

FIG. 3 is a graphic illustration of the relation between visible light transparency and strength, before and after the chemical strengthening treatment, according to the type of the rare earth element added.

FIG. 4 is a drawing illustrating the layout for the flexural strength test using a test piece.

FIG. 5 is a schematic sectional view illustrating the effect of incorporation of a rare earth element in the rare earth element-containing glass member according to the present invention.

FIG. 6 is also a schematic sectional view illustrating the effect of incorporation of a rare earth element in the rare earth element-containing glass member according to the present invention.

FIG. 7 is a graphic illustration of the relation between the content of Gd₂O₃ and average flexural strength in the femtosecond laser irradiated glass member.

FIG. 8 is a schematic sectional view illustrating the effect of femtosecond laser irradiation on the glass member samples of various compositions.

FIG. 9 is a graphic illustration of the relation between heat treatment temperature and average flexural strength.

FIG. 10 is a schematic plan illustrating the makeup of a display device using the glass member according to the present invention.

FIG. 11 is a perspective view showing the general structure of FED illustrated in FIG. 10.

FIG. 12 is a sectional view of FIG. 11.

### DESCRIPTION OF REFERENCE MARKS

HIG: high strength glass, HSL: high-density heterogeneous phase layer, MC: microcrack, UIG: ultra-high strength glass, ODG: ordinary glass, OIG: strengthened glass obtained by forming a high-density heterogeneous phase layer on ordinary glass, PNL1: back panel, PNL2: front panel, SUB1: back substrate, SUB2: front substrate, s (s1, s2, . . . sm): scanning signal lines, d (d1, d2, d3, . . . ): picture signal lines, ELS: electron source, ELC: connecting electrode, AD: anode, BM: black matrix, PH (PH(R), PH(G), PH(B)): phosphor layer, SDR: scanning signal line drive circuit, DDR: picture signal line drive circuit, SPC: spacer.

### DETAILED DESCRIPTION OF THE INVENTION

The best mode for carrying out the present invention is described below.

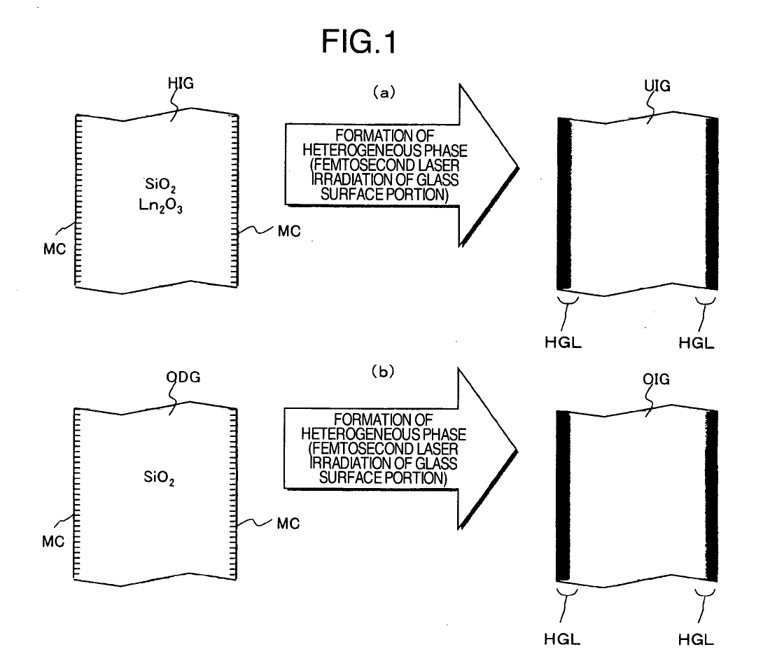

FIG. 1 is the diagrammatic drawings illustrating comparatively the means for glass strengthening treatment according to the present invention and the conventional means, in which FIG. 1(a) shows the strengthening means of the present invention and FIG. 1(b) shows the conventional means. Glass is shown by a partial section, and in the drawings, both right and left sides of each section are the surfaces. Ordinary glass is oxide-based glass whose main component is silicon oxide (SiO₂). In the present invention, as shown in FIG. 1(a), a rare earth oxide (Ln₂O₃) is added to the SiO₂ glass to make a high-strength glass HIG which has been strengthened in its whole body, and its surface portion is irradiated with femtosecond laser to form a heterogeneous phase region HGL on the glass surface. This heterogeneous phase region HGL serves for preventing occurrence of break due to the microcracks MC existing in the glass surface. According to the present invention, there can be obtained ultra-high strength glass, or so-called “unbreakable glass” UIG, which has six to twelve or even more times higher strength than ordinary glass.

On the other hand, according to the conventional strengthening means shown in FIG. 1(b), the ordinary oxide-based glass comprising silicon oxide with no rare earth oxide added is irradiated with femtosecond laser to form a heterogeneous phase region HGL as in the case of FIG. 1(a) to make ordinary strength glass OIG. Strength of this ordinary strength glass OIG is about 2 to 3 times that of ordinary glass. In both glass of FIG. 1(a) and glass of FIG. 1(b), the heterogeneous phase region HGL is positioned at a depth of 300 μm or less from the outermost surface of the glass.

The rare earth oxide added in the glass in the present invention is an oxide (Ln₂O₃) of Pr, Nd, Sm, Eu, Gd, Tb, Dy, Ho, Er, Tm, Yb or Lu, preferably an oxide (Ln₂O₃) of at least one element selected from Eu, Gd, Dy, Tm, Yb and Lu, more preferably an oxide of Gd. By incorporating such a rare earth oxide in the glass, high strengthening of the whole glass can be realized, and further by forming a heterogeneous phase region HGL on both surfaces, it is possible to obtain a glass with extremely high strength.

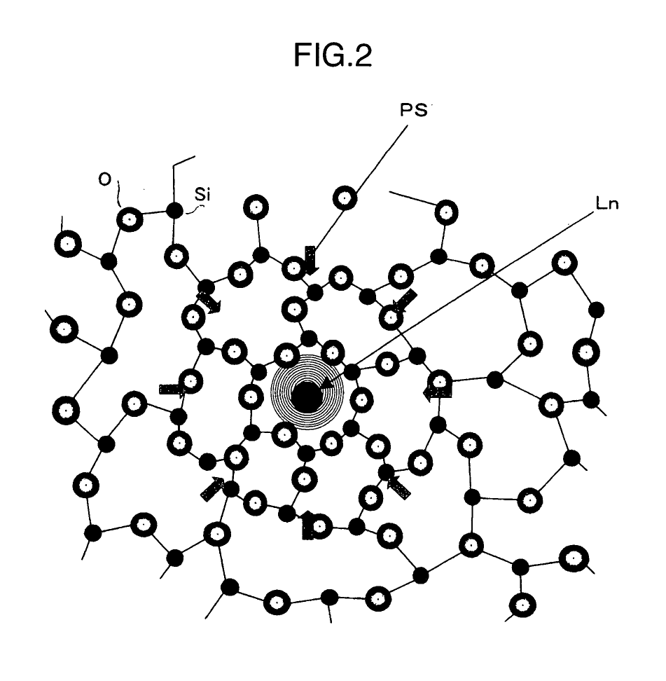

FIG. 2 is a diagrammatic illustration of the glass strengthening mechanism according to the present invention. The main component of the glass is SiO₂, and the glass has an oxygen skeletal structure shown in FIG. 2. It is considered that when a rare earth oxide Ln₂O₃ is added in this structure, the oxygen atoms O in the oxygen skeletal structure are attracted by the electric field of the added rare earth element Ln as shown by an arrow mark PS to strengthen the whole body of the glass.

The high-strength glass HIG which has been strengthened in its whole body by the addition of a rare earth oxide Ln₂O₃ is irradiated with femtosecond laser to form a heterogeneous phase region HGL on the glass surface, providing an ultra-high strength glass UIG which is proof against break caused by the microcracks.

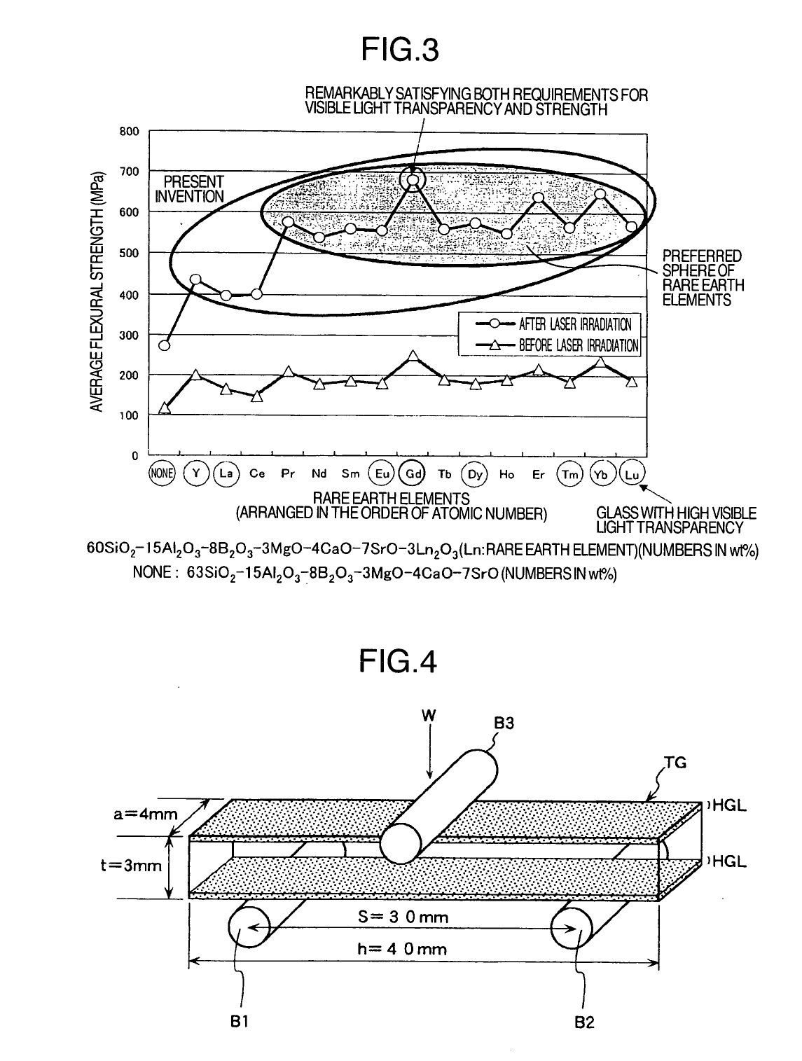

FIG. 3 is a graphic illustration of the relation between visible light transparency and strength before and after the chemical strengthening treatment according to the type of the rare earth element added. In the graph of FIG. 3, the rear earth elements are arranged in the order of elemental number on the horizontal axis, and average flexural strength (MPa) is plotted as ordinate. The composition and materials of the glass to which a rare earth oxide has been added, the amount of glass materials melted, the melting conditions, the annealing conditions and the flexural strength test conditions, which were used in the flexural strength test, are as described below. In the graph, average flexural strength of the high-strength glass HIG before irradiation with femtosecond laser is shown by the line connecting the plots of Δ, and average flexural strength of the ultra-high strength glass UIG after irradiation with femtosecond laser to form a heterogeneous phase region is shown by the line connecting the plots of ◯.

The above-mentioned average flexural strength test of the glass according to the present invention is explained here. In this average flexural strength test, the test pieces were made from the glass block described below and the method explained with reference to FIG. 4 was used.

(1) Making of Glass Block

Composition: 60 wt % SiO₂, 15 wt % Al₂O₃, 8 wt % B₂O₃, 3 wt % MgO, 4 wt % CaO, 7 wt % SrO and 3 wt % Ln₂O₃ (Ln: rare earth element).
Glass materials: SiO₂, Al₂O₃, B₂O₃, MgCO₃, CaCO₃, SrCO₃ and Ln₂O₃ (Ce alone was used in the form of CeO₃). (0.2 wt % of Sb₂O₃ was added as clearer).
Amount of the materials melted: about 300 g.
Melting conditions: The materials were melted at 1,600° C. for one hour (of which 0.5 hour was used for stirring, viz.glass homogenization).

The melt was cast into a mold to make a glass block, and it was overheated at 600° C. for one hour, then gradually cooled at a cooling rate of 1° C./min and straightened.

The composition of the glass to which no rare earth oxide was added (indicated by “No addition” in the drawing) was 63 wt % SiO₂, 15 wt % Al₂O₃, 8 wt % B₂O₃, 3 wt % MgO, 4 wt % CaO and 7 wt % SrO.

As indicated by an oval in FIG. 3, Pr and the other rare earth elements with a greater elemental number than Pr produce a high strength enhancing effect. The glass containing an oxide of an encircled rare earth element (encircled with ◯), viz. Y, La, Eu, Gd, Dy, Tm, Yb or Lu on the horizontal axis has high visible light transmittance and appears transparent, so that this glass is useful as a transparent glass member. A particularly high strengthening effect can be obtained by containing an element selected from Pr through Lu, and by containing an oxide of Gd, it is possible to satisfy, quite remarkably, both requirements for enhancement of strength and visible light transparency of the glass.

Further, by incorporating at least one element selected from the group consisting of Al element, B element and alkali earth metal elements in the oxide-based glass, the following effects can be obtained. That is, Al element (Al₂O₃) is effective for preventing devitrification and improving chemical stability, and B element (B₂O₃) is helpful for lowering glass making temperature and improving vitrification stability, while an alkali earth metal oxide (R′O) contributes to the improvement of Young's modulus.

In case a rare earth element is contained in an amount of 1 to 10% by weight, preferably 2 to 7% by weight calculated as an oxide thereof Ln₂O₃ (Ln: rare earth element) based on the whole oxide-based glass, if the amount of Ln₂O₃ contained in the oxide-based glass is less than 1% by weight, its effect of enhancing glass strength is unsatisfactorily small, but if its amount exceeds 10% by weight, it tends to cause devitrification (crystallization) of glass. Therefore, the amount of this element contained in the glass should be in the range of 1 to 10% by weight, preferably 2 to 7% by weight.

(2) Preparation of Test Pieces

The test pieces, each measuring 3 mm in thickness (t), 4 mm in width (a) and 40 mm in length (h), were made from the glass block made in (1) according to JIS R1601. Ten test pieces were prepared for each of the tests before and after laser irradiation.

(3) Conditions for Forming Heterogeneous Phase

Ultra-short pulse laser (YAG laser excited sapphire laser) was used under the following conditions: pulse width=200 femtoseconds; frequency=1 kHz; wavelength=780 nm; laser irradiated section=region to a depth of about 100 μm from the test piece surface; irradiated area=4×40 mm on both sides of the glass.

(4) Flexural Strength Test (3-Point Bending Test) Conditions

Three-point bending strength σ (MPa) was calculated from the following equation:
σ=(3s·w/2a·t²) (1)

wherein s: span of the lower portion; w: breaking load;

a: width of the test piece; t: thickness of the test piece.

FIG. 4 illustrates the layout of the flexural strength test using a test piece. In this flexural strength test, as shown in FIG. 4, there are used two lower columns B1, B2 arranged parallel to and spaced apart from each other by a span s, and an upper column B3 disposed at a higher level than and parallel to the lower columns B1, B2 and positioned halfway between these lower columns. Here, the span s between the lower columns B1, B2 is set at 30 mm, and the test piece TG is placed above the two lower columns B1, B2 with the heterogeneous phase regions HGL facing both upwards and downwards. The upper column B3 is positioned at a halfway point on the upper side of the test piece TG, and a load is applied in the direction of arrow W. The load at break of the test piece TG is expressed by w, and the flexural strength is calculated from the equation (1).

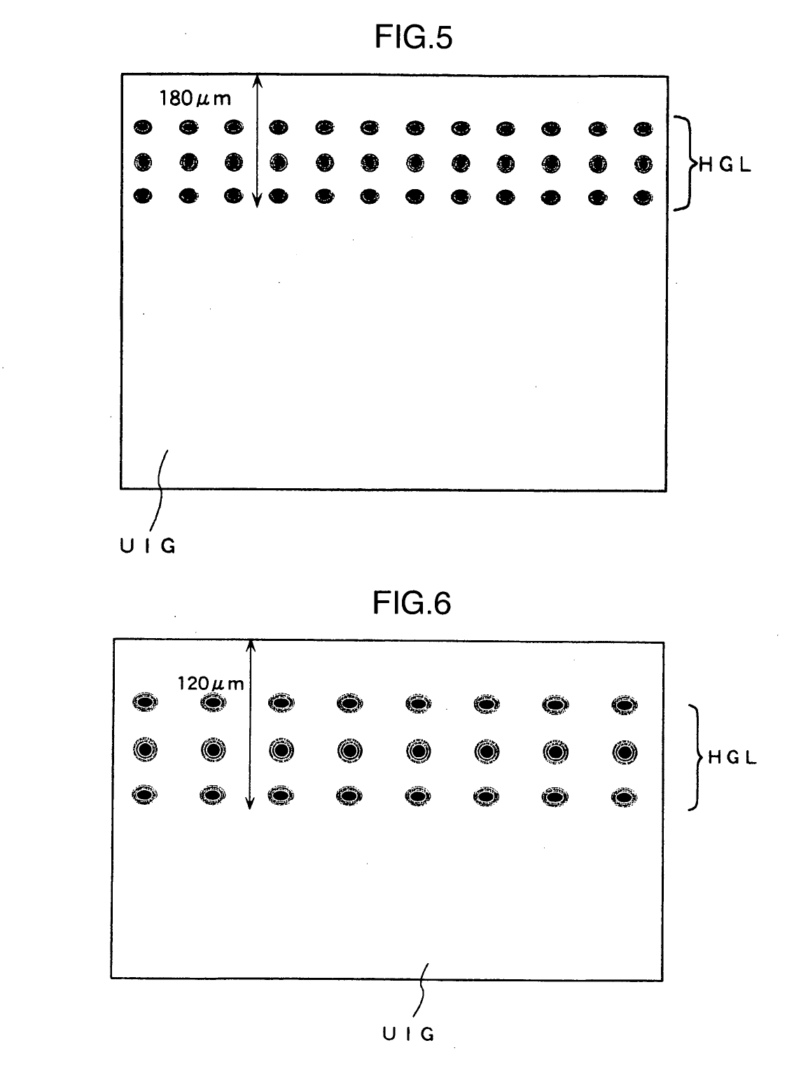

FIG. 5 is a schematic sectional view illustrating the effect of incorporation of a rare earth element in the rare earth element-containing glass according to the present invention. Shown in FIG. 5 is the result of observation and analysis, by an electron microscope, of the laser irradiated portion of the ultra-high strength glass UIG having a heterogeneous phase formed by applying femtosecond laser to the glass samples containing Gd, Er and Yb, respectively, as the rare earth elements which showed a remarkably high flexural strength enhancing effect. As shown in the drawing, a heterogeneous phase HGL is formed at a region close to the surface of the ultra-high strength glass UIG. It was detected that the rare earth element was contained in this heterogeneous phase HGL, too. The density of the rare earth element in this heterogeneous phase HGL has a tendency to become higher than that of the non-irradiated portion. It is considered that the glass flexural strength was remarkably enhanced by the presence of this heterogeneous phase.

The heterogeneous phase was found formed in the region to a depth of about 180 μm from the outermost surface of the glass. This region corresponds to the area where femtosecond laser was concentrated. Also, this heterogeneous phase was composed of a particulate precipitate, and it had high density and appeared to be crystallized.

FIG. 6 is a schematic sectional view illustrating the effect of the content of the rear earth elements in the rare earth element-containing glass according to the present invention. Here, the test pieces were prepared from the glass block described below, and subjected to the same average flexural strength test as explained above with reference to FIG. 4.

(1) Making of Glass Block

Composition: (68−x) wt % SiO₂, 15 wt % Al₂O₃, 2 wt % ZnO, 6 wt % Li₂O, 7 wt % Na₂O, 2 wt % K₂O and x wt % Gd₂O₃ (x indicates the content of Gd₂O₃).
Glass materials: SiO₂, Al₂O₃, ZnO, Li₂O₃, Na₂CO₃, KNO₃ and Gd₂O₃ (0.2 wt % of Sb₂O₃ was added as clearer).
Amount of materials melted: about 300 g
Melting conditions: 1,500-1,600° C. and 1.5 hour (of which 0.5 hour was used for stirring for glass homogenization).

The melt was cast into a mold to make a glass block, and it was overheated at 550° C. for one hour, then gradually cooled at a cooling rate of 1° C./min and straightened.

(2) Preparation of Test Pieces

The test pieces measuring 3 mm in thickness (t), 4 mm in width (a) and 40 mm in length (h) were made from the glass block made obtained in (1) according to JIS R1601. There were prepared 10 test pieces for each of the tests before and after laser irradiation.

(3) Conditions for Forming Heterogeneous Phase

Ultra-short pulse laser (YAG laser excited sapphire laser) was used under the following conditions: pulse width=200 femtoseconds; frequency=1 kHz; wavelength=780 nm; laser irradiated section: region to a depth of about 50 μm from the test piece surface; irradiated area: 4×40 mm on both sides of the glass.

In FIG. 6, this heterogeneous phase was formed in the region to a depth of about 120 μm from the outermost surface of the glass. This region corresponds to the area where femtosecond laser was concentrated. Regarding the content of Gd₂O₃, the following results were obtained after observation by an electron microscope.

When the content of Gd₂O₃ was 0 to 0.5% by weight, a high-density amorphous heterogeneous phase separated out. When the content of Gd₂O₃ was 1 to 3% by weight, a high-density Gd element-containing heterogeneous phase having a tendency to crystallize separated out. When the content of Gd₂O₃ was 5 to 10% by weight, a high-density Gd element-containing heterogeneous phase having crystallizability separated out. When the content of Gd₂O₃ was 15% by weight or higher, the formed phase had already a tendency to devitrify (crystallize), and there was observed no remarkable influence by laser irradiation.

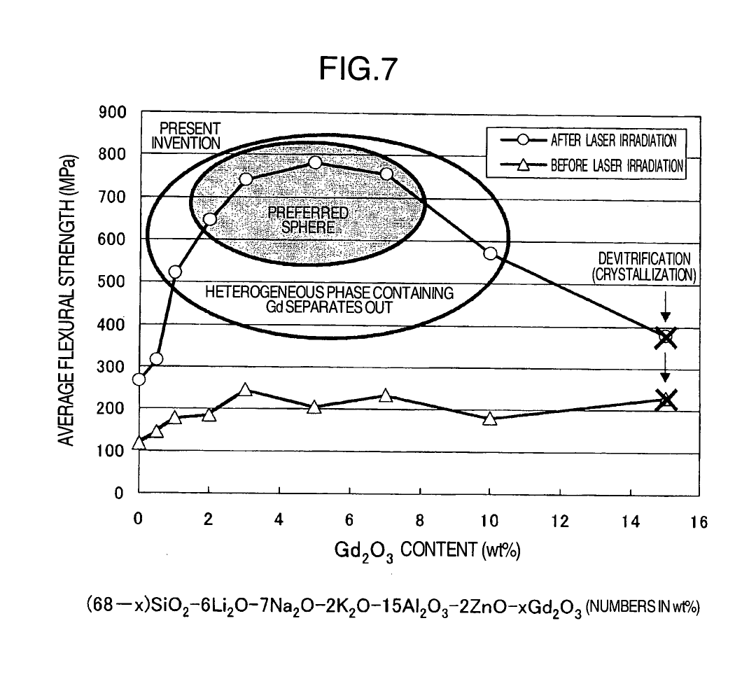

FIG. 7 is a graphic illustration of the relation of average flexural strength to Gd₂O₃ content in the glass irradiated with femtosecond laser. As shown in FIG. 7, in the region enclosed by an outer oval, there was seen separation of a heterogeneous phase containing Gd element in the glass, and its flexural strength exceeded 500 MPa, which is far higher than that of the non-irradiated glass. In the region enclosed by an inner oval, the flexural strength exceeded 700 MPa, providing quite desirable glass.

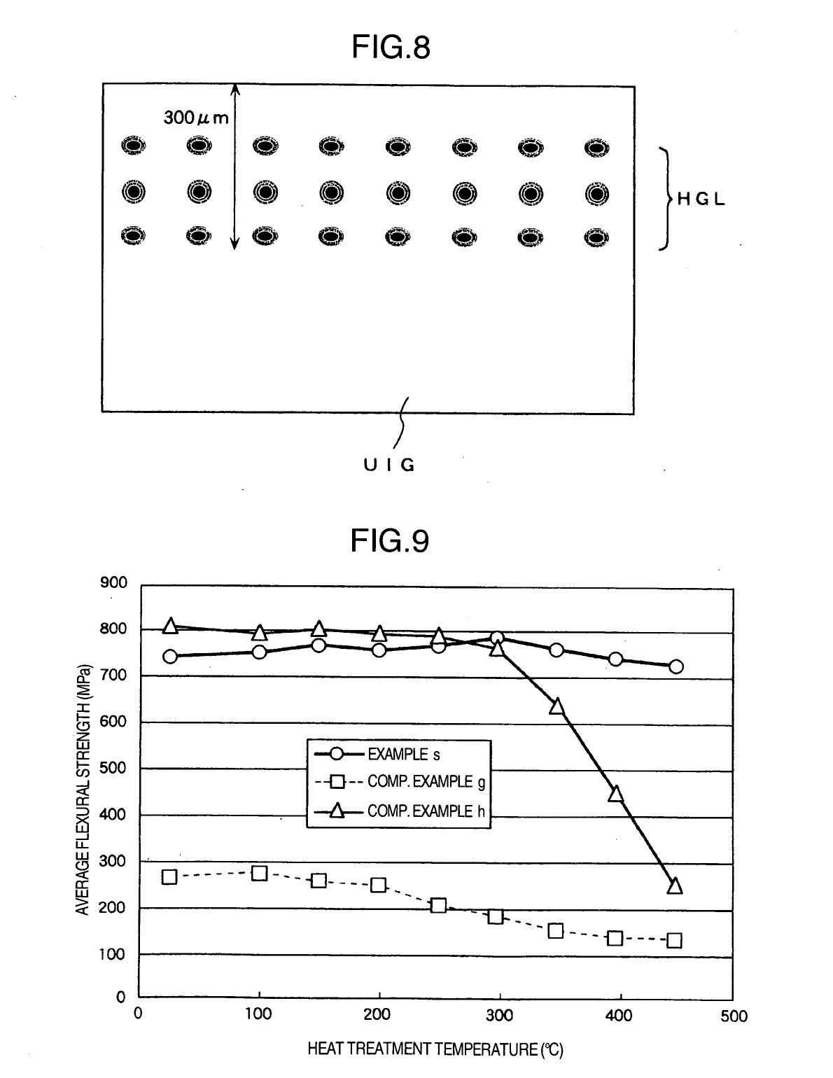

FIG. 8 is a schematic sectional view illustrating the effect of femtosecond laser irradiation on the glass samples of various compositions. Shown here are the glass samples (Examples a to q) of various compositions containing the rare earth elements shown in Table 1 and the glass samples (Comparative Examples a to f) of various compositions containing no rare earth element.

TABLE 1
Compositions and average 3-point bending strength after chemical strengthening treatment

| | | | | | | | | | | | | | | Flexural |
|---|---|---|---|---|---|---|---|---|---|---|---|---|---|---|
| | | | | | | | | | | | | | | Strength |
| | Gd₂O₃ | Er₂O₃ | Yb₂O₃ | SiO₂ | Li₂O | Na₂O | K₂O | Al₂O₃ | B₂O₃ | MgO | CaO | SrO | ZnO | (MPa) |
| Example a | 3 | — | — | 80 | 6 | 11 | — | — | — | — | — | — | — | 565 |
| Example b | 3 | — | 2 | 75 | 6 | 12 | 2 | — | — | — | — | — | — | 595 |
| Example c | — | — | 3 | 70 | 9 | 7 | 1 | 10 | — | — | — | — | — | 668 |
| Example d | 3 | — | — | 65 | 9 | 5 | 2 | 14 | — | — | — | — | 2 | 748 |
| Example e | 2 | 2 | 1 | 60 | 7 | 7 | 1 | 17 | 3 | — | — | — | — | 744 |
| Example f | 3 | 1 | — | 55 | 6 | 5 | — | 8 | 20 | — | — | — | 2 | 662 |
| Example g | — | 3 | — | 50 | 5 | 10 | 2 | 20 | 10 | — | — | — | — | 597 |
| Example h | — | — | 5 | 60 | 4 | 7 | — | 8 | 6 | 6 | 4 | — | — | 650 |
| Example i | 3 | — | — | 60 | — | — | — | 7 | 8 | 4 | 9 | 9 | — | 625 |
| Example j | 3 | — | — | 65 | 5 | 6 | 1 | 16 | — | 3 | — | — | 1 | 712 |
| Example k | 5 | — | — | 56 | 4 | 5 | — | 3 | 15 | 4 | 2 | 6 | — | 595 |
| Example l | 3 | — | — | 55 | 2 | 4 | 1 | 12 | 10 | 5 | — | 5 | 3 | 646 |
| Example m | 3 | 2 | — | 65 | 3 | 4 | 2 | 17 | — | 2 | — | — | 2 | 695 |
| Example n | 3 | — | 2 | 63 | 9 | 4 | 1 | 16 | — | — | — | — | 2 | 680 |
| Example o | 4 | — | — | 61 | — | — | — | — | 15 | 7 | 6 | 7 | — | 623 |
| Example p | 3 | 2 | 2 | 69 | 7 | 10 | — | 3 | — | 2 | 2 | — | — | 618 |
| Example q | — | 3 | 1 | 60 | 8 | 6 | 3 | 15 | 2 | — | — | — | 2 | 664 |
| Comp. | — | — | — | 70 | — | 15 | — | 2 | — | — | 13 | — | — | 265 |
| Example a | | | | | | | | | | | | | | |
| Comp. | — | — | — | 71 | 2 | 13 | 1 | 1 | — | 3 | 9 | — | — | 296 |
| Example b | | | | | | | | | | | | | | |
| Comp. | — | — | — | 58 | — | — | — | 3 | 15 | 7 | 8 | 7 | 2 | 270 |
| Example c | | | | | | | | | | | | | | |
| Comp. | — | — | — | 49 | 1 | 1 | 1 | 3 | 22 | 8 | 10 | 5 | — | 390 |
| Example d | | | | | | | | | | | | | | |
| Comp. | — | — | — | 65 | 6 | 8 | 1 | 16 | — | 3 | — | — | 1 | 320 |
| Example e | | | | | | | | | | | | | | |
| Comp. | — | — | — | 65 | 9 | 5 | 2 | 17 | — | — | — | — | 2 | 312 |
| Example f | | | | | | | | | | | | | | |

Glass materials: Gd₂O₃, Er₂O₃, Yb₂O₃, SiO₂, Li₂CO₃, Na₂CO₃, KNO₃, Al₂O₃, B₂O₃, MgCO₃, CaCO₃, SrCO₃ and ZNO. (0.2% by weight of Sb₂O₃ was used as clearer).
Amount of materials melted: about 300 g
Melting conditions: 1,600° C. and one hour (of which 0.5 hour was used for stirring (glass homogenization)).

The melt was cast into a mold to make a glass block, overheated at 600° C. for one hour, then gradually cooled at a cooling rate of 1° C./min and straightened.

As the test pieces for the flexural strength test, those measuring 3 mm in thickness (t), 4 mm in width (a) and 40 mm in length (h) were made from the said glass block according to JIS R1601. There were prepared 10 test pieces for each of the tests before and after laser irradiation.

For forming the heterogeneous phase, ultra-short pulse laser, viz. YAG laser excited sapphire laser, was used under the following conditions: pulse width=200 femtoseconds; frequency=1 kHz; wavelength =780 nm; laser irradiated section: region to the depth of about 200 μn from the test piece surface; irradiated area: 4×40 mm on both sides.

A 3-point bending test was conducted for determining the flexural strength. The 3-point bending strength σ (MPa) was calculated from the following equation:
σ=(3s·w/2a·t²)

From observation by an electron microscope, it was found that in the ultra-high strength glass UIG obtained by irradiating the rare earth element-containing glass with femtosecond laser, a heterogeneous phase HGL was formed to the depth of 100-300 μm, the region where femtosecond laser was concentrated, from the outermost surface of said glass UIG.

Next, heat resistance of the glass according to the present invention is explained. In the glass which has undergone the chemical strengthening treatment (alkali ion exchange in the glass surface) which is one of the conventional means for strengthening glass surface, the alkali ions are diffused to the surface on heating to reduce strength. Such reduction of strength on heating can be prevented by the surface strengthening treatment comprising femtosecond laser irradiation according to the present invention. This technique is particularly useful for the structural members of the devices which require a heat treatment in their production process, such as flat panel displays (FPD) and magnetic discs.

In the heat resistance improvement test, there were used the glass samples of the following compositions:
Glass A: 63 wt % SiO₂, 6 wt % Li₂O, 7 wt % Na₂O, 2 wt % K₂O, 2 wt % Al₂O₃, 2 wt % ZnO and 5 wt % Gd₂O₃.
Glass B: 68 wt % SiO₂, 6 wt % Li₂O, 7 wt % Na₂O, 2 wt % K₂O, 2 wt % Al₂O₃ and 2 wt % ZnO.
Glass materials: Gd₂O₃, Er₂O₃, Yb₂O₃, SiO₂, Li₂CO₃, Na₂CO₃, KNO₃, Al₂O₃, B₂O₃, MgCO₃, CaCO₃, SrCO₃ and ZnO. (Sb₂O₃ was added in an amount of 0.2% by weight as clearer).
Amount of the materials melted: about 300 g.
Melting conditions: 1,600° C. and one hour (of which 0.5 hour was used for stirring—glass homogenization).

The melt was cast into a mold to make a glass block, and it was overheated at 600° C. for one hour, then gradually cooled at a cooling rate of 1° C./min and straightened.

The size of the test pieces was 3 mm in thickness (t), 4 mm in width (a) and 40 mm in length (h). As means for strengthening the test pieces, a heterogeneous phase containing a rare earth element was formed on glass A in the same way as illustrated in FIG. 6, and this was represented by “Example r”. A heterogeneous phase was similarly formed on glass B, and this was represented by “Comparative Example g”. A conventional chemical strengthening treatment (alkali ion exchange) was applied on glass A as “Comparative Example h”. Thickness of the compression stress layer in Comparative Example h was 20 to 40 μm.

The heat treatment of the test pieces was conducted at 100° C., 150° C., 200° C., 250° C., 300° C., 350° C., 400° C. and 450° C. for 10 minutes for each temperature. There were prepared 5 test pieces for the test at each of the above temperatures. The flexural strength test conditions were the same as illustrated in FIG. 4.

FIG. 9 is a graph illustrating the relation of average flexural strength to heat treatment temperature, in which the test results on “Example r”, “Comparative Example g” and “Comparative Example h” are shown. It is seen from FIG. 9 that in “Example r”, the reduction of strength is only slight even at 300° C. or higher temperatures. In “Example r”, the fine crystallizable particles containing a rare earth element separate out to form a heterogeneous phase. Since this heterogeneous phase is little affected by the heat treatment, the reduction of strength is limited.

In contrast, in “Comparative Example h”, a sharp drop of strength occurs at 300° C. or above. This is because the alkali ions which have undergone ion exchange in the heat treatment are diffused to the surface. Also, in “Comparative Example g”, there takes place a drop of strength at 200° C. or above. This is because the heterogeneous phase is faded out by the heat treatment.

A steel ball drop test on the glass according to the present invention is explained below. The compositions of the glass samples used for this test were as follows.
Glass A: 63 wt % SiO₂, 6 wt % Li₂O, 7 wt % Na₂O, 2 wt % K₂O, 15 wt % Al₂O₃, 5 wt % ZnO and 5 wt % Gd₂O₃.
Glass B: 68 wt % SiO₂, 6 wt % Li₂O, 7 wt % Na₂O, 2 wt % K₂O, 15 wt % Al₂O₃ and 2 wt % ZnO.
Glass C: 67 wt % SiO₂, 4 wt % Li₂O, 8 wt % Na₂O, 1 wt % K₂O, 15 wt % Al₂O₃ and 2 wt % ZnO.
Glass D: 62 wt % SiO₂, 5 wt % Li₂O, 4 wt % Na₂O, 8 wt % K₂O, 4 wt % MgO, 4 wt % CaO, 9 wt % SrCO₃ and 4 wt % BaO.
Glass materials: SiO₂, Li₂CO₃, Na₂CO₃, KNO₃, Al₂O₃, ZNO, Gd₂O₃, MgCO₃, CaCO₃, SrCO₃ and BaCO₃ (0.5% by weight of Sb₂O₃ was added as clearer)
Amount of the materials melted: about 10 kg
Melting conditions: 1,500-1,600° C. and 5 hours (of which 3 hours was used for stirring—glass homogenization).

The melt was cast into a mold to make a 150 mm×150 mm×150 mm cubic glass block, and it was heated at 550-600° C. for 2 hours, then gradually cooled at a cooling rate of 1° C./min and straightened.

The 150 mm×150 mm×2.5 mm test pieces were prepared from this glass block and subjected to the following strengthening treatments.
(1) To glass A, ultra-short pulse laser (YAG laser excited sapphire laser, or femtosecond laser: pulse width=200 femtoseconds; frequency=1 kHz; wavelength=780 nm) was applied to a depth of about 100 μm from the glass surface to form a heterogeneous phase containing a rare earth element. Laser irradiation area was 4 mm×40 mm on both sides of the glass . . . “Example s”
(2) Glass C was subjected to the same laser irradiation as conducted on glass A to form a heterogeneous phase containing a rare earth element . . . “Example t”
(3) Glass B was subjected to the same laser irradiation as conducted on glass sample A to form a heterogeneous phase containing no rare earth element . . . “Comparative Example i”
(4) Glass D was subjected to the same laser irradiation as conducted on glass sample A to form a heterogeneous phase containing no rare earth element . . . “Comparative Example j”
(5) Glass B (with no heterogeneous phase formed) . . . “Comparative Example k”
(6) Glass C (with no heterogeneous phase formed) . . . “Comparative Example 1”
(7) Glass D (with no heterogeneous phase formed) . . . “Comparative Example m”

An impact test was conducted on the above glass samples according to JIS C8917. In the test, a steel ball of 450 g in mass was dropped to each test piece from the heights of 25 cm, 50 cm, 75 cm, 100 cm and 125 cm. 3 test pieces were used in the drop test for each height. The results of the tests are shown in Table 2. In Table 2, ◯ indicates no test piece fractured, Δ indicates part of the test pieces fractured, and x indicates all of the test pieces fractured.

TABLE 2
Impact fracture test

| | 25 cm | 50 cm | 75 cm | 100 cm | 125 cm |
|---|---|---|---|---|---|
| Example s | ∘ | ∘ | ∘ | Δ | x |
| | | | | 1 test | |
| | | | | piece | |
| | | | | fractured | |
| Example t | ∘ | ∘ | ∘ | ∘ | x |
| Comp. | ∘ | ∘ | x | x | x |
| Example i | | | | | |
| Comp. | ∘ | Δ | x | x | x |
| Example j | | 2 test | | | |
| | | pieces | | | |
| | | fractured | | | |
| Comp. | ∘ | x | x | x | x |
| Example k | | | | | |
| Comp. | ∘ | ∘ | x | x | x |
| Example l | | | | | |
| Comp. | Δ | x | x | x | x |
| Example m | 2 test | | | | |
| | pieces | | | | |
| | fractured | | | | |

As seen from Table 2, the test pieces of rare earth element-containing glass subjected to the chemical strengthening treatment comprising formation of a heterogeneous phase according to the present invention (Examples s and t) suffered no fracture by drop of the steel ball from the heights of up to 75 cm, with only one test piece being fractured by drop of the steel ball from the height of 100 cm in Example s. In Comparative Examples i to m, all of the test pieces were fractured by the drop of the steel ball from the height of 75 cm. This indicates that the rare earth element-containing glass having a heterogeneous phase formed in its surface according to the present invention has far higher strength than the glass samples of the Comparative Examples.

As viewed above, the glass member according to the present invention has required strength even if small in thickness, and when it has a large thickness, its safety and reliability are appreciably increased. Thus, the scope of use of the present invention is not limited to the electronic devices such as panel glass for FPD and solar batteries; the invention can be applied as well to the fields of buildings, vehicles, aircraft, spacecraft, etc.

Here, the results of the tests on impact fracture resistance of the laminated glass (glass laminates) according to the present invention are explained. The compositions of the test pieces and the glass materials are the same as used in the impact fracture tests on the single-layer glass (glass C) described above, but the amount of the materials melted was about 17 kg and the melting conditions were 1,500° C. and 6 hours (of which 3.5 hours was used for stirring and homogenization of glass). The melt was cast into a mold to make an approximately 150 mm×150 mm×220 mm glass block, and it was heated at 550° C. for 3 hours, then gradually cooled a cooling rate of 1° C./min and straightened.

The following 3 different test pieces were cut out from the said glass block and subjected to optical polishing:
Test piece for single layer glass: 150 mm×150 mm×3.0 mm
Test piece for 2-layer glass: 150 mm×150 mm×1.5 mm
Test piece for 3-layer glass: 150 m×150 mm×1.0 mm

The chemical strengthening treatment was the same as conducted on said glass C, that is, a heterogeneous phase containing a rare earth element was formed.

After forming a chemically strengthened layer, a synthetic resin EVA (ethylene-vinyl acetate copolymer) was sandwiched between the test pieces for 2-layer glass and pressed together to make 2-layer laminated glass, and this glass was presented here as “Example v”. EVA was also sandwiched between the respective test pieces for 3-layer glass and pressed together to make 3-layer laminated glass, which was presented as “Example x”. The attached layer thickness was about 0.3 mm. The test piece for single-layer glass is intended for comparison with laminated glass, and it is designed so that the overall thickness of glass exclusive of the resin will be equal to the glass thickness of 2-layer laminated glass (1.5 mm+1.5 mm=3.0 mm) and the glass thickness of 3-layer laminated glass (1.0 mm+1.0 mm+1.0 mm=3.0 mm). This single-layer glass is presented as “Example u”.

Table 3 shows the results of the impact facture test by drop of a steel ball on the 2-layer and 3-layer glass laminates, along with the test results on the test piece for single-layer glass with the same thickness. The mass of the steel ball used was 1.0 kg. This test was also a test according to JIS C8917 in which, with the layout described above, a steel ball of 1.0 kg in mass was dropped onto the test piece from the heights of 25 cm, 50 cm, 75 cm, 100 cm, 125 cm and 150 cm. Three test pieces were used in the drop test for each height. In Table 3, ◯ indicates no test piece fractured, Δ indicates part of the test pieces fractured, and x indicates all of the test pieces fractured.

TABLE 3
Impact fracture test on glass laminates

| | 25 cm | 50 cm | 75 cm | 100 cm | 125 cm | 150 cm |
|---|---|---|---|---|---|---|
| Example u: | ∘ | ∘ | Δ | x | x | x |
| single | | | (2 test pieces | scattering and | scattering and | scattering and |
| | | | fractured) | falling occurred | falling occurred | falling occurred |
| | | | scattering and | | | |
| | | | falling occurred | | | |
| Example v: | ∘ | ∘ | ∘ | Δ | x | x |
| 2-layer | | | | (2 test pieces | No scattering | No scattering |
| laminate | | | | fractured) | and falling | and falling |
| | | | | No scattering | | |
| | | | | and falling | | |
| Example x: | ∘ | ∘ | ∘ | ∘ | Δ | x |
| 3-layer | | | | | (1 test piece | No scattering |
| laminate | | | | | fractured) | and falling |
| | | | | | No scattering | |
| | | | | | and falling | |

As seen from the results shown in Table 3, the laminated glass made by using the rare earth element-containing glass having a heterogeneous phase formed in its surface according to the present invention (Examples v and x) is appreciably strengthened in comparison with the single-layer glass (Example u) of the same thickness, and even if such laminated glass is fractured, there takes place no scattering of its fragments.

The present invention described above may be summarized as follows.

In the present invention, a high-density heterogeneous phase containing a rare earth element is formed in the surface portion of the glass by applying ultra-short pulse laser, such as femtosecond laser, to the surface portion of the glass containing a rare earth element. This high-density heterogeneous phase containing a rare earth element prevents the microcracks from growing to the larger cracks when a flexural stress is exerted to the glass. Since formation of this heterogeneous phase does not depend on alkali ion exchange in the glass surface portion as conducted in the chemical strengthening treatment, there is no need of containing an alkali in the glass to be strengthened.

In the femtosecond laser irradiated portion, the particles containing a rare earth element separate out uniformly in the glass surface portion to form a high-density heterogeneous phase, which strengthens the glass surface and prevents growth of the microcracks to the larger cracks. Incorporation of a rare earth element in the glass enables formation of a heterogeneous phase with high density and high crystallinity.

As the rare earth element, Pr, Nd, Sm, Eu, Gd, Tb, Dy, Ho, Er, Tm, Yb and Lu can be used, of which Eu, Gd, Dy, Tm, Yb and Lu are preferred, with Gd being the most preferred. The glass containing Eu, Gd, Dy, Tm, Yb or Lu has high light transmittance in the visible light region, and by containing Gd in particular, it is possible to satisfy, quite remarkably, both requirements for enhancement of strength and good light transmittance in the visible light region.

Irradiation with ultra-short pulse laser such as femtosecond laser used in the present invention, unlike ordinary laser irradiation, gives no thermal influence to the glass, so that no strain is left in the glass after laser irradiation. Also, since a heterogeneous phase is formed to a depth within 300 μm from the outermost surface of the glass, a high strengthening effect can be obtained. Further, by forming the heterogeneous phase on both front and back sides of the glass, a higher degree of strengthening can be realized.

When the content of Ln₂O₃ is less than 1% by weight, its strength enhancing effect is small. When its content exceeds 10% by weight, the treated glass tends to devitrify (crystallize). In view of this, the preferred range of content of Ln₂O₃ is 2 to 7% by weight.

The scope of use of the glass member according to the present invention is not limited to the structural components of the display devices such as FPD and the glass structural members of electronic devices such as substrates of magnetic discs; the glass of this invention can be also applied widely to the other objectives such as structural materials and window glass (including 2-layer glass and laminated glass) of buildings, substrates for solar batteries, structural members and window glass of vehicles, aircraft, spacecraft, etc., for which high strength as well as reduction of size and weight are required.

In the following, an example of flat panel display (FPD) which is one of the most promising fields of application of the glass of the present invention is explained.

As one of the self-emission type FPD having an electron source arranged as a matrix, there are known field emission displays (FED) and electron emission displays utilizing the cold cathodes capable of integration with low power. For these cold cathodes, there are used, for instance, spindt-type electron source, surface conduction type electron source, carbon nanotube type electron source, metal-insulator-metal (MIM) laminate type, metal-insulator-semiconductor (MIS) laminate type, and metal-insulator-semiconductor-metal type thin-film electron sources.

Self-emission type FPD has a display panel comprising a back panel provided with electron sources such as mentioned above, a front panel provided with phosphor layers and an anode issuing an accelerating voltage for bombarding the electrons emitted from the electron sources, and a sealing frame for sealing the inside space between the two opposing panels in a prescribed evacuated state. The back panel has the said electron sources formed on a back substrate, and the front panel has the phosphor layers formed on a front substrate and an anode issuing an accelerating voltage for forming an electric field for bombarding the electrons emitted from the electron sources against the phosphor layers. A drive circuit is combined with this display panel. Usually, the back panel, front panel and sealing frame are made of glass. By using the said glass of the present invention for these parts, it is possible to realize an FPD which is small in size and weight and resistant to breakage.

Each electron source makes a pair with a corresponding phosphor layer to constitute a unit picture element. Usually, one pixel (color pixel) is composed of unit picture elements of three colors, viz. red (R), green (G) and blue (B). In the case of color pixel, the unit picture element is also called sub-pixel.

The front and back panels are separated by a member called spacer to keep a prescribed space between them. This spacer is a plate-like member made of an insulating material such as glass or ceramic or a material having a certain degree of conductivity, and it is provided for each group of pixels at a position where it will not hinder the movement of the pixels. By using the glass of the present invention for this spacer, it is possible to realize a thin, light-weight and breakage-resistant FPD.

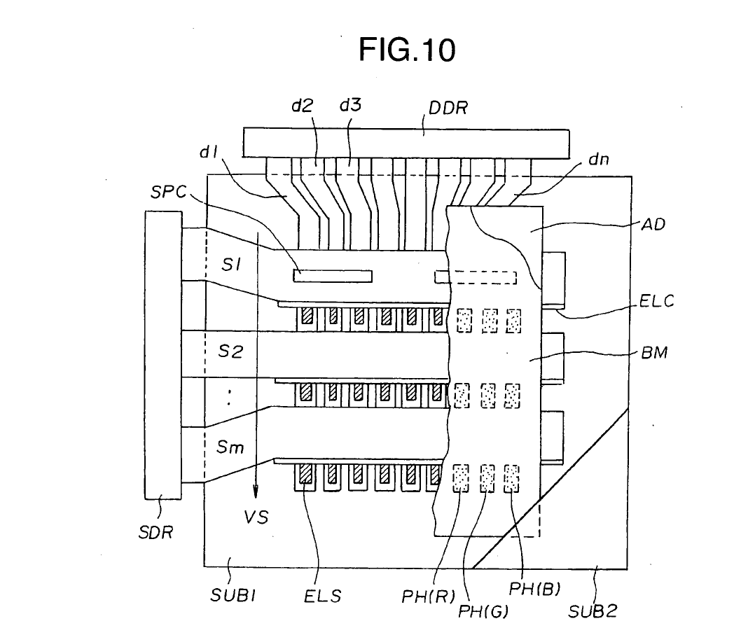

FIG. 10 is a diagrammatic plan showing the structure of a display device using the glass according to the present invention. The back substrate SUB1 of the back panel is made of the glass according to the present invention. Picture signal lines d (d1, d2, . . . dn) are formed on the inner surface of the substrate, and scanning signal lines s (s1, s2, s3, . . . sm) are formed thereon crossing the lines d. The picture signal lines d are driven by a picture signal drive circuit DDR, and the scanning signal lines s are driven by a scanning signal drive circuit SDR. In FIG. 10, spacers SPC are provided above the scanning signal line s1, and the electron sources ELS are provided on the downstream side of the spacers SPC in the vertical scanning direction VS. Power is supplied from the connecting electrodes ELC through the scanning signal lines s (s1, s2, s3, . . . sm). These spacers SPC are also made of the glass of the present invention.

The front substrate SUB2 of the front panel is made of the glass according to the present invention. An anode electrode AD is provided on the inner surface of the substrate, and phosphor layers PH (PH(R), PH(G), PH(B)) are formed on said anode electrode AD. With this arrangement, the phosphor layers PH (PH(R), PH(G), PH(B)) are comparted by a light shielding layer (black matrix) BM. The anode electrode AD is shown as a solid electrode, but it may be constituted as stripe electrodes arranged to cross the scanning signal lines s (s1, s2, s3, . . . sm) and divided for each row of pixels. The electrons emitted from the electron sources ELS are accelerated and bombarded against the phosphor layers PH (PH(R), PH(G), PH(B)) constituting the corresponding sub-pixels. Consequently, the said phosphor layers PH emit light with a prescribed color and it is mixed with the color of the light emitted from the phosphor of the other sub-pixels to constitute a color pixel of a prescribed color.

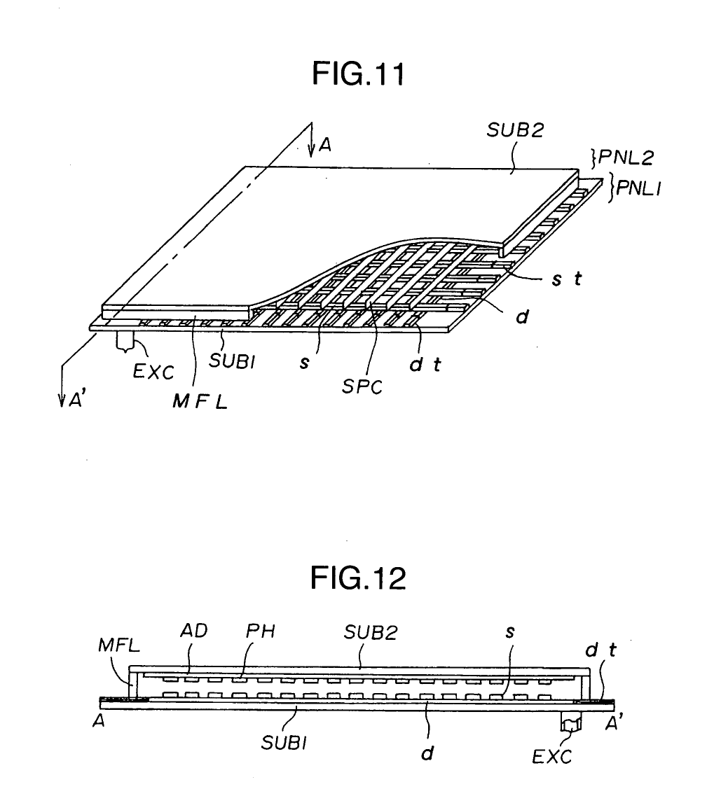

FIG. 11 is a perspective view showing the whole structure of the FED explained with reference to FIG. 10, and FIG. 12 is a sectional view thereof. FIG. 12 shows a glass section cut parallel to the spacers SPC which are not shown in the drawing. On the inner surface of the back substrate SUB1 of the back panel PNL1, there are provided picture signal lines d and electron sources disposed close to the crossings of the matrices of scanning signal lines s. Picture signal lines d are led out to the outside of the sealing frame MFL to form leader terminals dt. Similarly, scanning signal lines s are also lead out to the outside of the sealing frame MFL to form leader terminals st. On the other hand, an anode AD and phosphor layers PH are provided on the inner side of the front substrate SUB2 of the front panel PNL2. Anode AD comprises an aluminum layer.

The front panel PNL2 and the back panel PNL1 are opposed to each other, and in order to keep a prescribed space between them, the rib-like spacers SPC of approximately 80 μm in width and approximately 2.5 mm in height are provided above and in the extending direction of the scanning signal wiring and secured in position by using fritted glass or other means. A glass-made sealing frame MFL is provided at the peripheral edges of both panels and fixed in position by fritted glass (not shown) so that the internal space held by both panels will be isolated from the outside.

For fixing the spacers with fritted glass, they are heated at 400-450° C., and then the system is evacuated to about 1 μPa through an evacuating tube 303 and then sealed. In operation, a voltage of about 5-10 kV is applied to the anode AD on the front panel PNL2.

It should be further understood by those skilled in the art that although the foregoing description has been made on embodiments of the invention, the invention is not limited thereto and various changes and modifications may be made without departing from the spirit of the invention and the scope of the appended claims.

1. A glass member containing at least a rare earth element, said glass member having formed at its surface portion a strengthened layer of a heterogeneous phase which contains at least said rare earth element.

2. The glass member according to claim 1 wherein said heterogeneous phase comprises a particulate precipitate.

3. The glass member according to claim 1 or 2 wherein the density of said heterogeneous phase is higher than that of an inside portion of the glass.

4. The glass member according to claim 1 or 2 wherein said heterogeneous phase is crystalline.

5. The glass member according to claim 1 wherein said rare earth element is at least one element selected from the group consisting of Pr, Nd, Sm, Eu, Gd, Tb, Dy, Ho, Er, Tm, Yb and Lu.

6. The glass member according to claim 5 wherein said rare earth element is at least one element selected from the group consisting of Eu, Gd, Dy, Tm, Yb and Lu.

7. The glass member according to claim 6 wherein said rare earth element is at least Gd.

8. The glass member according to claim 1 wherein said heterogeneous phase is formed by an irradiation with an ultra-short pulse laser.

9. The glass member according to claim 1 or 8 wherein said heterogeneous phase exists in a region of 300 μm or less in depth from an outermost surface of said glass.

10. The glass member according to claim 9 wherein said heterogeneous phase is formed on both a front surface and a back side of said glass.

11. The glass member according to claim 1, 5, 6 or 7 wherein said rare earth element is contained in an amount of 1 to 10% by weight calculated as an oxide thereof Ln₂O₃ (Ln: rare earth element) based on the whole glass.

12. The glass member according to claim 11 wherein said rare earth element is contained in an amount of 2 to 7% by weight calculated as an oxide thereof Ln₂O₃ (Ln: rare earth element) based on the whole glass.
